(19) United States
(12) Patent Application Publication
(10) Pub. No.: US 2024/0217087 A1
(43) Pub. Date: Jul. 4, 2024

(54) CAR SEAT SEATBELT ASSIST DEVICE

(71) Applicant: Bridget Ann Burling, Winter Haven, FL (US)

(72) Inventor: Bridget Ann Burling, Winter Haven, FL (US)

(21) Appl. No.: 18/346,777

(22) Filed: Jul. 3, 2023

Related U.S. Application Data
(60) Provisional application No. 63/358,072, filed on Jul. 1, 2022.

(51) Int. Cl. B25J 1/04; B25G 1/10

(52) U.S. Cl. CPC B25J 1/04; B25G 1/10

(57) ABSTRACT

Seat belt assistive devices to aid a user in installing a car seat into a vehicle described.

### FIELD

Some implementations relate generally to infant and child car seats, and, more particularly, to a device to assist with installing a car seat into vehicle.

### BACKGROUND

Handling the car seat belt when installing a car seat into a vehicle can be challenging because of a need to reach behind or through the car seat in some cases to thread the vehicle seat belt through to secure the car seat in place. Handling the seat belt can be a challenge for people with hand or body mobility issues, or for people with large hands, etc.

Embodiments were conceived in light of the above-mentioned problems and limitations, among other things. The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a diagram showing a side view of an example seat belt assistive device in accordance with some implementations.

FIG. 2 is a diagram showing a side view of an example seat belt assistive device in accordance with some implementations.

FIG. 3 is a diagram showing a top view of an example seat belt assistive device in accordance with some implementations.

FIG. 4 is a diagram showing a top view of an example seat belt assistive device in accordance with some implementations.

FIG. 5 is a diagram showing a top view of an example seat belt assistive device in accordance with some implementations.

FIG. 6 is a diagram showing a top view of an example seat belt assistive device in accordance with some implementations.

FIG. 7 is a diagram showing a top view of an example seat belt assistive device in accordance with some implementations.

FIG. 8 is a diagram showing a first view of an example seat belt assistive device usage sequence in accordance with some implementations.

FIG. 9 is a diagram showing a second view of an example seat belt assistive device usage sequence in accordance with some implementations.

FIG. 10 is a diagram showing a third view of an example seat belt assistive device usage sequence in accordance with some implementations.

### DETAILED DESCRIPTION

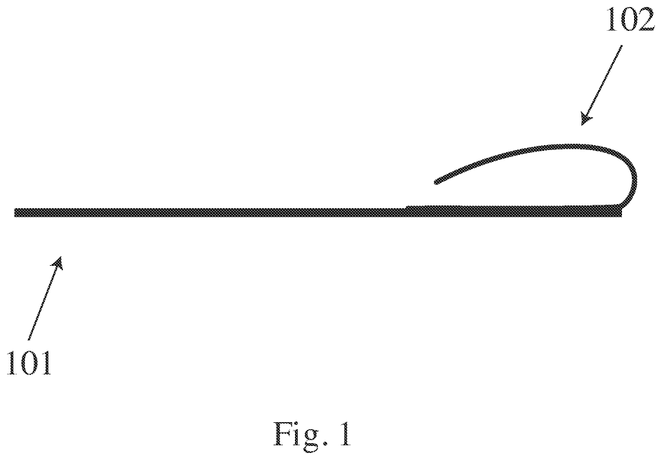

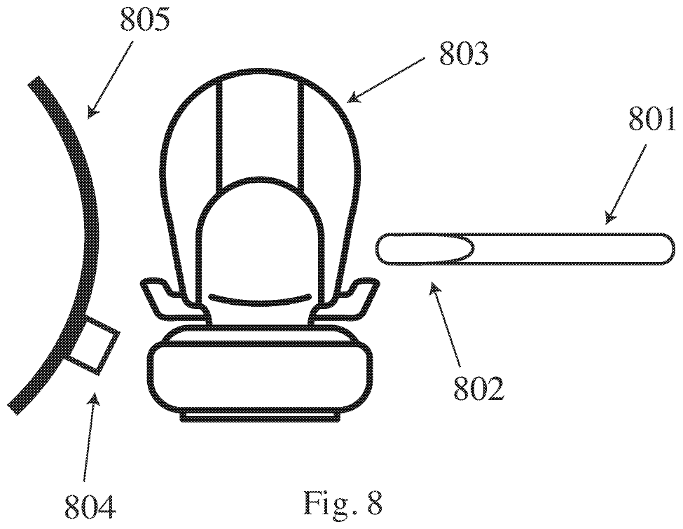

FIG. 1 is a diagram showing a side view of an example seat belt assistive device in accordance with some implementations. In particular, the seat belt assistive device includes an elongate handle 101 and a hook 102 that are integrated into a single piece (e.g., via molding). Where the user holds the elongate handle 101 at an end opposite the hook 102 and the hook 102 is used to releasably engage a seat belt of a vehicle. Details of the usage of the seat belt assistive device are shown in the sequence of FIGS. 8-10.

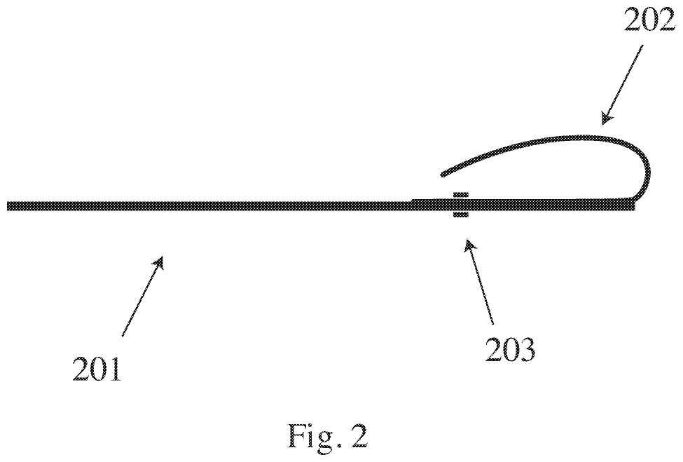

FIG. 2 is a diagram showing a side view of an example seat belt assistive device in accordance with some implementations. In particular, the seat belt assistive device includes an elongate handle 201, a hook 202, and a fastener 203 (e.g., a bolt/nut, a screw, an adhesive, etc.). Where the user holds the elongate handle 201 at an end opposite the hook 202 and the hook 202 is used to releasably engage a seat belt of a vehicle. Details of the usage of the seat belt assistive device are shown in the sequence of FIGS. 8-10.

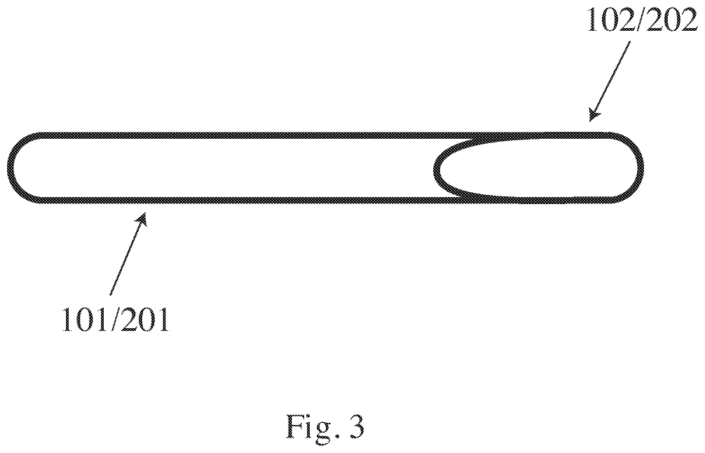

FIG. 3 is a diagram showing a top view of an example seat belt assistive device (e.g., similar to that shown in FIGS. 1 and 2) in accordance with some implementations. In particular, the seat belt assistive device includes an elongate handle 101/201 and a hook 102/202. Where the user holds the elongate handle 101/201 at an end opposite the hook 102/202 and the hook 102/202 is used to releasably engage a seat belt of a vehicle. Details of the usage of the seat belt assistive device are shown in the sequence of FIGS. 8-10.

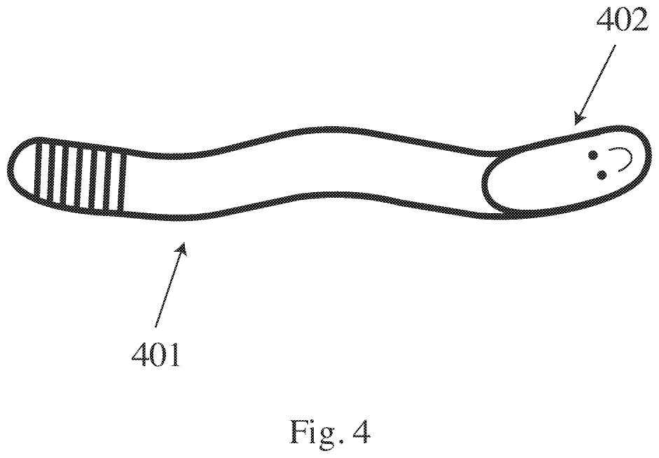

FIG. 4 is a diagram showing a top view of an example seat belt assistive device in accordance with some implementations. In particular, the seat belt assistive device includes an elongate handle 401 and a hook 402 that are either integrated into a single piece (e.g., via molding) or attached by a fastener. Where the user holds the elongate handle 401 at an end opposite the hook 402 and the hook 402 is used to releasably engage a seat belt of a vehicle. Details of the usage of the seat belt assistive device are shown in the sequence of FIGS. 8-10.

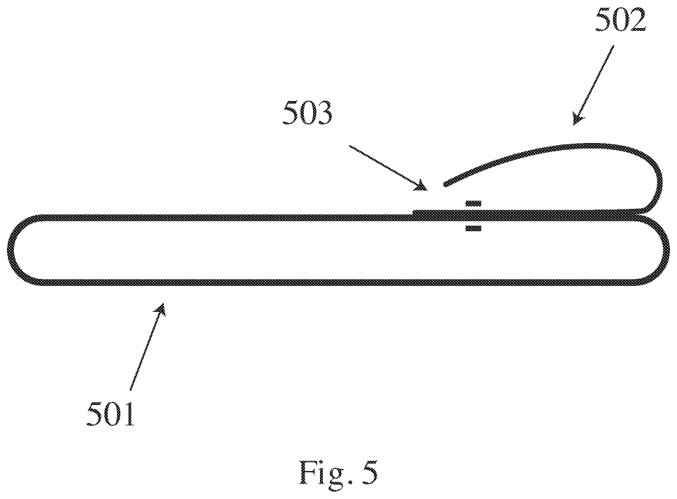

FIG. 5 is a diagram showing a top view of an example seat belt assistive device in accordance with some implementations. In particular, the seat belt assistive device includes an elongate handle 501, a hook 502 (mounted on a side of the elongate handle), and a fastener 503 (e.g., a bolt/nut, a screw, an adhesive, etc.). Where the user holds the elongate handle 501 at an end opposite the hook 502 and the hook 502 is used to releasably engage a seat belt of a vehicle. Details of the usage of the seat belt assistive device are shown in the sequence of FIGS. 8-10.

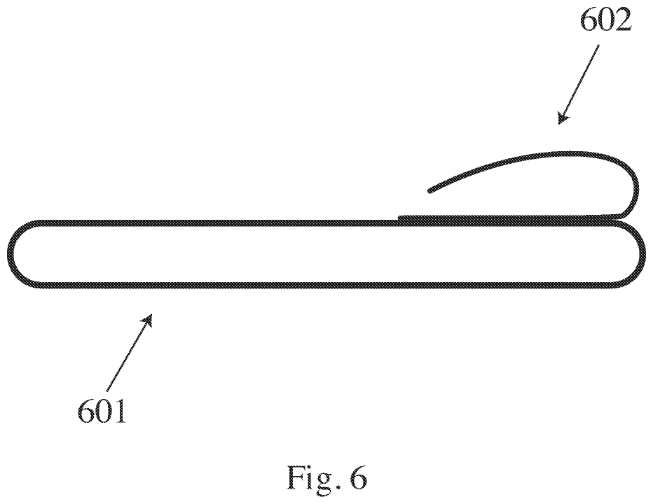

FIG. 6 is a diagram showing a top view of an example seat belt assistive device in accordance with some implementations. In particular, the seat belt assistive device includes an elongate handle 601 and a hook 602 that are integrated into a single piece (e.g., via molding) where the hook is formed on the edge of the elongate handle. Where the user holds the elongate handle 601 at an end opposite the hook 602 and the hook 602 is used to releasably engage a seat belt of a vehicle. Details of the usage of the seat belt assistive device are shown in the sequence of FIGS. 8-10.

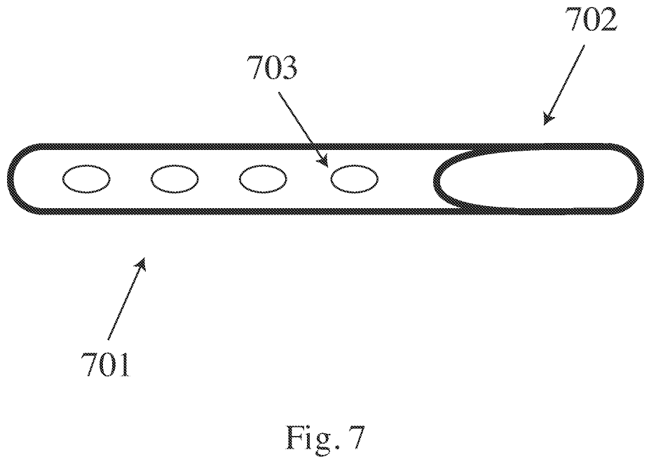

FIG. 7 is a diagram showing a top view of an example seat belt assistive device in accordance with some implementations. In particular, the seat belt assistive device includes an elongate handle 701, a hook 702 that are integrated into a single piece (e.g., via molding) or a fastener, and holes 703 formed in the elongate handle 701 to reduce weight and material usage, for example. Where the user holds the elongate handle 701 at an end opposite the hook 702 and the hook 702 is used to releasably engage a seat belt of a vehicle. Details of the usage of the seat belt assistive device are shown in the sequence of FIGS. 8-10.

FIG. 8 is a diagram showing a first view of an example seat belt assistive device usage sequence in accordance with some implementations. In particular, a user can hold the elongate handle 801 by the end opposite the hook 802. A car seat 803 is being installed into a vehicle via a seatbelt 805 and seat belt buckle 804.

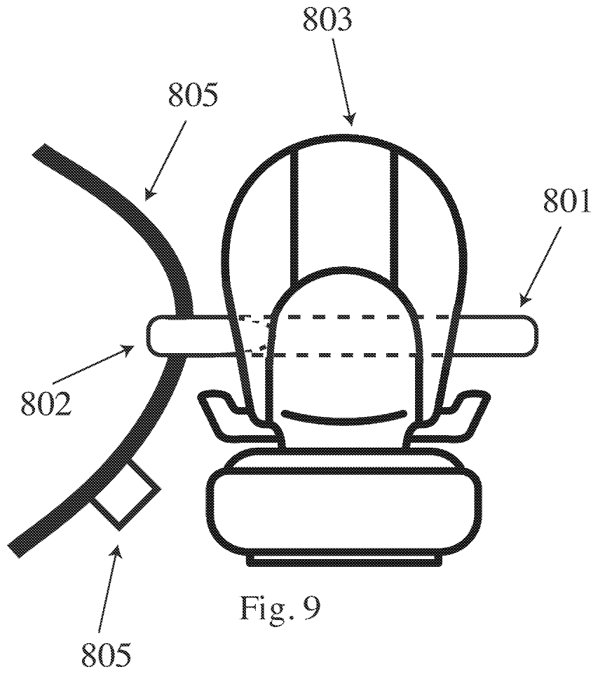

FIG. 9 is a diagram showing a second view of an example seat belt assistive device usage sequence in accordance with some implementations. In this view, the elongate handle 801 has been used to insert the elongate handle 801 and the hook 802 behind the car seat 803 to releasably engage the seat belt 805 using the hook 802.

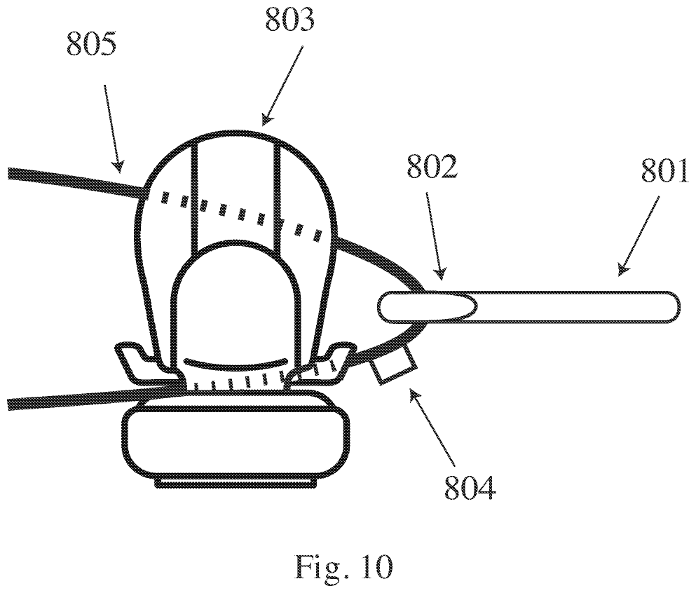

FIG. 10 is a diagram showing a third view of an example seat belt assistive device usage sequence in accordance with some implementations. The handle 801 is then pulled back from behind the car seat 803 with the seat belt 805 releasably engaged by the hook 802 so that the user can then fasten the seat belt 805 using the seat belt buckle 804. Thus, the seat belt assistive device can help reduce or eliminate the need for a user to reach their hand behind the car seat 803.

Any of the seat belt assistive devices described herein can be made from rubber, plastic, metal, wood, a combination of two or more of the above, or any other suitable material or combination of materials.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

1. A seat belt assistive device comprising:
an elongate handle; and
a hook that is integrated into a single piece with the elongate handle, wherein a user holds the elongate handle at an end opposite the hook and the hook is used to releasably engage a seat belt of a vehicle.
